(19) United States
(12) Patent Application Publication
(10) Pub. No.: US 2026/0307357 A1
(43) Pub. Date: Oct. 8, 2026

(54) METHOD FOR OPERATING A CORRUGATOR, CORRUGATOR, COMPUTER PROGRAMME PRODUCT, AND PAPER ROLL

(71) Applicant: BHS Corrugated Maschinen- und Anlagenbau GmbH, Weiherhammer (DE)

(72) Inventor: Thomas Meenken, Floß (DE)

(21) Appl. No.: 18/998,422

(22) PCT Filed: Sep. 12, 2023
(86) PCT No.: PCT/EP2023/074988

§ 371 Date: Jan. 24, 2025

(30) Foreign Application Priority Data
Sep. 14, 2022 (DE) 10 2022 209 636.3

(51) Int. Cl. B31F 1/22

(52) U.S. Cl. CPC B31F 1/22

(57) ABSTRACT

The invention relates to a method for operating a corrugator (2), the corrugator (2) being used to produce a corrugated cardboard web (4) and having a number of adjustable operating parameters (6) for this purpose, a number of paper rolls (12) being fed to the corrugator (2), each having a paper web made of a paper from which the corrugated cardboard web (4) is produced, the paper of each paper roll (12) being characterized by a number of paper parameters (14) which have individual values for each of the paper rolls (12) so that the paper of each paper roll (12) is individually characterized on the basis of its values for the paper parameters (14), and the operating parameters (6) being adjusted depending on the values of the paper parameters (14) so that the production of the corrugated cardboard web (4) is individually adapted to the paper of the fed paper roll (12). The invention also relates to a corrugator (2), a computer program product, and a paper roll (12).

The invention relates to a method for operating a corrugator, as well as to a corrugator, a computer program product, and a paper roll.

A corrugator is used to produce a corrugated cardboard web. The corrugator is fed with several paper webs in the form of paper rolls. The paper rolls are unwound using a respective unwinder of the corrugator, and the paper webs thus produced are joined together to form a corrugated cardboard web using several processing units. Here, for example, one of the paper webs is corrugated with a corrugating roller, and then glued to two non-corrugated paper webs. Multi-layer corrugated cardboard webs with more than one corrugated paper web are also possible. The finished corrugated cardboard web is then optionally finished using the corrugator, i.e., cut into individual pieces and, if necessary, slit and/or grooved.

The quality of the corrugated cardboard web produced depends on the one hand upon the choice of appropriate values for the operating parameters of the corrugator in operation (i.e., during the production of the corrugated cardboard web), but on the other hand also upon the properties of the paper webs from which the corrugated cardboard web is produced. The operating parameters are set, for example, during operation of the corrugator and manually by an operator or automatically depending upon measurements using sensors directly in front of a respective processing unit (inline measurement). In this way, it is possible to react to changing environmental conditions as well as to varying properties of the paper webs. For example, temperature and moisture controls are conceivable for adjusting the temperature and moisture of a particular paper web as part of a control system for the corrugator, in order to influence the processing result of a particular processing unit as optimally as possible immediately before this processing unit.

U.S. Pat. No. 11,162,226 B2 describes a process in which a paper web is conditioned with a liquid film in order to obtain a certain moisture content. The conditioning depends upon a hygroexpansivity attribute which is measured for or assigned to the paper web. The measurement of the hygroexpansivity attribute is based upon a subsequent measurement of the shape of the finished corrugated cardboard, from which the hygroexpansivity attribute is then calculated, so that similar paper webs can then be assigned the same hygroexpansivity attribute. Accordingly, the assignment of the hygroexpansivity attribute is generally based upon the fact that similar paper webs can be assigned the same hygroexpansivity attribute.

Additionally, reference is made to U.S. Pat. No. 10,095,206B2, EP 3 392 649B1, EP 3 369 564B1, EP 2 572 038B1, EP 2 406 616B1, EP 2 391 505B1, EP 1 902 833A1, EP 0 936 059A2, DE 10 2017 219 064A1, DE 10 2015 206 650 A1, CN 107 458 032 A, CN 107 631 684 A, CN 112 644 092 B, CN 207 105 756 U, and CN 210 553 357 U.

Against this background, it is an object of the invention to improve the production of a corrugated cardboard web. For this purpose, a suitable method for operating a corrugator, a corresponding corrugator, as well as a computer program product and an advantageous paper roll are to be specified.

The object is achieved according to the invention by a method having the features according to claim 1, a corrugator having the features according to claim 13, a computer program product having the features according to claim 14, and a paper roll having the features according to claim 15. Advantageous embodiments, further developments, and variants are the subject of the dependent claims. The statements in connection with the method also apply analogously to the corrugator, the computer program product, and the paper roll, and vice versa. If steps of the method are specified below, advantageous embodiments of the corrugator result from the fact that the corrugator is designed to carry out one or more of these steps (in particular by means of a control unit of the corrugator). Analogously, advantageous embodiments for the computer program product result in that it comprises commands which, when executed by a corrugator, cause it to carry out one or more of these steps.

A core idea of the invention is in particular the use of paper data in a corrugator, as well as the supply (also transmission) of this paper data to the corrugated cardboard layer.

The method according to the invention serves to operate a corrugator. This in turn is used to produce a corrugated cardboard web and has a number of adjustable operating parameters. An operating parameter is adjusted by selecting and setting a value for that operating parameter. The operating parameters are used to control the behavior of one or more processing units of the corrugator. Examples of the processing units are unwinder, splicer, printer, single facer, bridge, preheater, gluing unit, double facer, drying section, cutting unit, slitting unit, grooving unit, and the like. However, the details of the processing units are not important in this case. Examples of operating parameters are: conveyor speed, tension, ink quantity, corrugating roller temperature, glue quantity, water quantity for moistening, drying temperature, cutting and/or grooving position, and the like. The details of the processing parameters are also not important at this point.

In the method, a number of paper rolls are fed to the corrugator, each with one (i.e., at least one) paper web of paper, from which the corrugated cardboard web is made. In other words, the corrugator is fed with a number of paper rolls during operation. Here and in general, “a number of” is understood to mean “one or more” or “at least one.” A respective paper roll is formed in particular by a paper web and a sleeve (also referred to as a bushing), on which the paper web is rolled up, which is unwound by the corrugator for producing the corrugated cardboard web by means of an unwinder and is suitably connected to further paper webs of other paper rolls. A particular paper web is made of paper or consists of paper. The processing units then process the paper webs according to the operating parameters, i.e., each operating parameter is assigned to at least one of the processing units and defines their behavior during operation and thus the processing of the paper web by this processing unit.

In particular, several paper rolls are fed into the corrugator in two ways. On the one hand, several paper rolls are fed to the corrugated cardboard web, the paper webs of which are connected to each other as different layers of the corrugated cardboard web, i.e., several paper rolls for different layers are fed more or less simultaneously. On the other hand, several paper rolls are also fed to the corrugated cardboard web one after the other in order to realize continuous operation, i.e., after a paper roll has been used up, a new paper roll is fed in, so that several paper rolls are fed for the same layer.

The paper rolls are each characterized by a number of paper parameters, which have individual values for each of the paper rolls, so that each of the paper rolls is individually characterized based upon its values for the paper parameters. More specifically, the paper of each paper roll is characterized by a number of paper parameters, which have individual values for each of the paper rolls, so that the paper of each paper roll is individually characterized based upon its values for the paper parameters. The paper parameters thus specifically characterize the paper of a particular paper roll; however, for the sake of simplicity, reference will be made occasionally to the paper roll only, in which case what is meant in particular is the paper on it. The values of the paper parameters of a single paper roll are also referred to as “paper data” and together form a data set for that paper roll. The paper parameters each describe, directly or indirectly, one or more properties of the paper on the paper roll, so that different values mean or imply different properties. The term “paper parameters” is particularly broadly defined and does not mean only physical, mechanical, chemical properties of the paper itself, but any information that enables the characterization of the paper, e.g., place of manufacture, time of manufacture, storage time of the paper, or operating parameters of a paper machine during the production of the paper and the like. In a suitable embodiment, the paper data are averaged values or spatially and/or temporally resolved values (e.g., spatially resolved moisture along the length and width of the paper web) or a combination thereof. Which paper parameters are used exactly is initially irrelevant; what is more important here is that the values of the paper parameters are available individually for each of the paper rolls. For example, the paper parameter is a fiber orientation of the paper in the paper roll, and the corresponding value is a for a first paper roll, b for a second paper roll, and c for a third paper roll.

The value of the paper parameter is therefore individual for each paper roll (more precisely, its paper), but this does not exclude the possibility that two paper rolls do not also have the same value for a certain paper parameter. As a rule, however, the papers of two paper rolls differ in one or more of the paper parameters due to their production, storage, transport, etc., and therefore have different properties. This individuality of the paper rolls in the present case is taken into account and used in the operation of the corrugator, and thus in the processing of the paper rolls, in order to optimize the production of the corrugated cardboard web. For this purpose, the operating parameters of the corrugator are set depending upon the values of the paper parameters (i.e., depending upon the paper data), so that the production of the corrugated cardboard web is individually adapted to the paper roll (i.e., its paper) that is processed at a given time. In other words, since the properties of the paper regularly differ from paper roll to paper roll (and possibly even along a single paper roll), the operation of the corrugator is adapted accordingly to the paper roll used, preferably on a recurring and/or continuous basis. The paper data is not or not exclusively determined in the corrugator, but beforehand, and in particular away from and independently of the corrugator. The paper data advantageously contain the history and/or the previous life of the paper in the paper roll, so that the paper data represent, so to speak, a life story of the paper roll. In particular, the paper data do not necessarily contain only those paper parameters that could also be determined inline in the corrugator, but, advantageously, also those paper parameters that, in principle, cannot be determined within the corrugator, e.g., paper production process parameters. The method presented here is therefore dynamic, in that individual properties of the paper roll are taken into account. The above applies analogously when several paper rolls are processed simultaneously, the paper data of which are then used jointly to set the operating parameters. The paper parameters them-selves -and thus the paper data as a whole-are static, i.e., constant for the paper of an entire paper roll, or dynamic, i.e., vary along the paper of the paper roll, so that, for example, a parameter curve results as a function of the section of the paper web that is currently being unwound. A combination is also possible, so that one or more paper parameters are static, and one or more other paper parameters are dynamic.

In the present case, it is assumed, without loss of generality, that there are several paper rolls, each with several paper parameters, and that several operating parameters are set depending upon the paper parameters. This is also generally preferred.

In this case, it is advantageous that the paper parameters of a respective paper roll are used to set the operating parameters of the corrugator and are thus used in particular directly to set the operating parameters and thus also to control the corrugator. This is in contrast to the aforementioned U.S. Pat. No. 11,162,226B2, in which a respective paper roll is first assigned a hygroexpansivity attribute, based upon a comparison with other paper rolls, on the basis of which the conditioning within the corrugator is then adjusted. This means that the operating parameters are not adjusted depending upon the specific properties of a particular paper roll. In addition, an allocation is made using a purely data-based model, which is correlated across several corrugators from different corrugated cardboard manufacturers and wherein, essentially, the operating parameters of the corrugators are compared with each other. However, similar or even unchanged paper data are assumed (e.g., same manufacturer or same production slot). In other words, the approach in U.S. Pat. No. 11,162,226 B2 aims to use the data from different corrugators, whereas the present invention aims to use the paper data from paper rolls with regularly different paper properties, possibly even only for a single corrugator.

In general, outside the corrugator, certain paper parameters of a paper roll, even if these paper parameters are known, have not yet been used to control the corrugator. This is also not necessary at first, because, by focusing only on the corrugated cardboard layer itself, feedback control is also possible, in which the operating parameters are readjusted based upon the corrugated cardboard web produced. However, such a reaction and the subsequent adjustment inevitably lead to rejects or at least a non-optimal product being produced in the meantime, which reduces the economic efficiency of the corrugator. By contrast, the corrugator presented here has an advantageously shortened control loop due to the use of paper parameters for control. Since the values of the paper parameters are known very early in the operation and in particular before the paper roll is even processed, the control system also re-acts accordingly in advance to any changes in the values of the paper parameters. The control system here is therefore in particular a feedforward control. In a feedback control, however, the manufactured output product (the corrugated cardboard web) would be examined—as already described—and the operating parameters would then be controlled retroactively depending upon this, i.e., the output product provides the input signal for the control system. In the feedforward control described here and advantageously used, however, the input product (the paper roll) provides the input signal for the control system in order to control (more precisely, to control in a closed-loop manner) the operating parameters and to obtain a specific output product.

Preferably, the values used for the paper parameters of a single paper roll are aggregated as far as possible, i.e., received by the corrugator from as few different sources as possible and preferably only from a single source, and thus as a data set that is summarized to the greatest possible extent. The paper data are therefore preferably not transferred to the corrugator at different locations and/or at different times, but collected in a single data set and/or at a single time. Optionally, the paper data of several paper rolls can even be aggregated in such a way that it is still possible to assign individual values to a single paper roll-expediently, by means of an ID for each paper roll.

The invention initially makes use of the observation that the properties of the paper in a paper roll are fundamentally determined by its production and can then change further as a result of its development (transport, storage, and the like). When the paper roll is actually fed into the corrugator and processed in it, the values of the paper parameters of each paper roll have developed according to its individual life cycle, so that, basically, no two paper rolls are completely identical. By treating different paper rolls in the same way until processing, it is in principle possible to keep the properties of these paper rolls as similar as possible, so that processing under the same operating parameters leads to tolerable fluctuations in the quality of the corrugated cardboard web. In practice, this may be sufficient in many cases, but in any case it requires compliance with certain tolerances when producing the paper.

The invention now also opens up the potential that results from the fact that the properties of the paper of a particular paper roll are actually taken into account individually, so that even small differences are compensated for by adjusting the operating parameters accordingly, in order to produce a corrugated cardboard web of maximum quality starting from a paper roll with given properties. A further advantage of the invention described here is that, correspondingly, paper rolls can be produced with greater tolerance, since any deviations from values defined as ideal for the paper parameters are now optimally compensated for by the corrugator during operation. This makes it easier and more cost-effective to produce paper and paper rolls in general. In addition, paper rolls that would previously have been discarded due to severe defects can now also be used. It is now also possible to use paper rolls that are not normally intended for the production of corrugated cardboard, because, due to the now known paper data and its use, basically any paper roll can be used optimally and purposefully for the production of corrugated cardboard. Ultimately, this means that paper and paper rolls in general can be produced more cost-effectively or are more cost-effective to procure, with a corresponding advantage for the corrugated cardboard web.

In this case, the individual properties of the paper in a paper roll are profitably used to optimize the process control of the corrugator. In other words, the individual properties of a paper roll are used to control the corrugator, so that its operation then depends upon the individual values of the paper parameters of each paper roll. This means that the corrugator is controlled individually for each roll. This requires in particular that the paper data of the respective paper roll are known and available before their processing and preferably as early as possible, and are therefore not determined by means of appropriate sensors only immediately before a respective processing station. Preferably, the paper data are already known before the paper is fed into a paper roll of the corrugator. Alternatively or additionally, the values of the paper parameters of a respective paper roll are measured using suitable sensors within the corrugator, but not immediately before a respective processing unit or even afterwards, but already when the paper roll is unwound in the unwinder or immediately afterwards, i.e., before the paper web is processed in a processing unit (e.g., printer, single facer, preheater, gluing unit). Accordingly, the method presented here differs from an inline measurement precisely in that the paper data are fed into the paper roll in advance and, in particular, are also used, and not only when needed or subsequently. This avoids non-optimal products and rejects.

A particular advantage is that the paper data can be used for plausibility checks, calibration, or testing of sensors in the corrugator and are also expediently used for this purpose. The value of a paper parameter is then determined using a sensor on the corrugator and compared with the value stored for this paper parameter in the paper data. Based upon this, at least the afore-mentioned options for action arise: plausibility check, calibration, and testing of the sensor. For example, moisture sensors in the corrugator have a measurement inaccuracy, which is corrected and/or correlated using the paper parameter “moisture” from the paper data of the paper roll.

A further advantage is in particular that the energy requirement for producing a corrugated cardboard web from the respective paper roll (i.e., for processing the paper roll) can be determined using the paper data, preferably the temperature and moisture of the paper. Accordingly, in an expedient embodiment, an energy requirement is determined based upon the paper data of a paper roll and indicates how much energy is needed to produce a corrugated cardboard web from the paper roll.

Preferably, values for the operating parameters are selected on the basis of a rule which links the values of the paper parameters with the values for the operating parameters in such a way that a quality measure for the corrugated cardboard web is changed, in particular improved, in particular maximized. The quality measure is basically arbitrary; an example of a suitable quality measure is the extent of bending of the corrugated cardboard sheet, also known as “warp,” or the proportion of rejects, i.e., what proportion of the corrugated cardboard sheet cannot be used as intended due to faulty manufacturing. Another suitable quality measure is a strength value of the corrugated cardboard web, in particular edge crush resistance (e.g., according to ECT=Edge Crush Test), flat crush resistance (e.g., according to FCT=Flat Crush Test), or the like and generally any corrugated cardboard property. A combination of several quality measures is also advantageous. The rule is learned in a suitable form, i.e., it is generated in advance in a learning process in which the quality measure is measured as a function of the paper parameters and the operating parameters. The rule is then derived from this function. Various approaches are suitable for the learning process, but the details are not important here.

In the present case, the operating parameters are advantageously set not only indirectly, but directly dependent upon the values of the paper parameters. The rule already described is here in particular a function for which the paper parameters are then input parameters and for which the operating parameters are correspondingly output parameters. The values of the paper parameters are converted by the corrugator directly into suitable values for the operating parameters in accordance with the-in particular, predefined-rule, and these values are then also set. A determination of intermediate parameters is preferably not carried out. This is in contrast to the aforementioned U.S. Pat. No. 11,162,226B2, in which the hygroexpansivity attribute is first determined for a given paper web, in order to then obtain suitable operating parameters for the conditioning of the paper web. This is not necessary in the present case, since the aforementioned rule links the paper parameters directly with the operating parameters, thus saving upon corresponding calculations and preliminary considerations. This is based in particular upon the realization that knowledge of the causal relationships or causalities is not important, but that it is sufficient to determine the rule empirically in advance through appropriate experiments, training procedures, and/or a Big Data approach. In this respect, the rule itself is not necessarily known, but, rather, a kind of black box which outputs corresponding values for the operating parameters only for given paper data. For example, the rule is implemented by a neural network or the like, e.g., in a virtual sensor. In principle, different solutions are conceivable and suitable, which achieve similar or identical results in different ways.

Which paper parameters are actually used is initially of secondary importance and becomes less relevant as the number of paper parameters increases. Accordingly, preferably at least 10 paper parameters are used, in particular at least 100. The total volume of paper data results primarily from the number of values stored for the respective paper parameters. A static paper parameter contains only a single value (e.g., running meter on the paper roll, production date, or mean value of a dynamic paper parameter), whereas a dynamic paper parameter contains a large number of values (e.g., moisture as a function of width and length of the paper roll), which depends in particular upon the value density/sampling rate (e.g., 1/cm) and is regularly in the range of 1,000 to 1,000,000 or more. The paper parameters do not necessarily have to be in an immediately recognizable, causal relationship to the quality measure for the corrugated cardboard web. Especially in the Big Data approach mentioned above, knowledge of relations is of secondary importance. However, some paper parameters regularly have a greater influence on the quality of the corrugated cardboard web than other paper parameters and are therefore preferred, especially when only a few (i.e., at most 10) paper parameters are used. Therefore, in a suitable embodiment, one or more of the paper parameters are selected from the following paper parameters: fiber orientation of the paper of the paper roll, failure stress of the paper of the paper roll.

In an expedient embodiment, two of the paper rolls which are fed to the corrugator for simultaneous processing are selected such that they do not differ from each other by more than a maximum value in at least one of the paper parameters. In other words, two of the paper rolls that are also processed at the same time are as similar as possible. The setting of the operating parameters depending upon the values of the paper parameters is simplified by selecting paper rolls that are as similar as possible. This is particularly advantageous with regard to moisture. Accordingly, in a suitable embodiment, one of the paper parameters is a moisture content of the paper of a respective paper roll. It is then expedient to additionally select two of the paper rolls (which are fed to the corrugator for simultaneous processing) such that their moisture con-tents do not differ from each other by more than a maximum value, in particular 2% (relative to each other). In other words, paper rolls with as similar moisture content as possible are selected. The two paper rolls are then also processed simultaneously and form in particular different layers of the corrugated cardboard web, preferably two outer layers of the corrugated cardboard web, i.e., a top side and a bottom side. The underlying consideration is that, if the moisture content deviates too much, i.e., if it deviates more than the maximum value, it may no longer be possible to produce a corrugated cardboard sheet, or at least it may not be possible to guarantee sufficient quality. Since the paper parameters are advantageously accessible in this case, it is possible to select the paper rolls in such a way that they fit together optimally, especially with regard to the respective moisture content of the paper as described.

Particularly preferably, at least one of the paper parameters is a dynamic paper parameter the values of which are specified as a function of the width and/or length of the paper web of the paper roll. By contrast, static paper parameters have the same value along the entire paper web. Suitable dynamic paper parameters are: fiber orientation as a function of a width and/or length of the paper web, temperature as a function of a width and/or length of the paper web, e.g., in the form of a “heat map,” which indicates the temperature at a particular point on the paper web, and moisture as a function of a width and/or length of the paper web, analogously, for example, in the form of a “moisture map.” A dynamic paper parameter is distinguished in that it has potentially different values at different points on the paper web and therefore describes an inhomogeneity of the paper roll. Using one or more dynamic paper parameters results in a more detailed picture of the paper roll, which is advantageously used when setting the operating parameters. The operating parameters are then accordingly adjusted dynamically.

It is also useful to use paper production process parameters, i.e., process parameters which were used in the production of the paper of a particular paper roll. The paper production process parameters are not immediate, direct properties of the paper (such as moisture, fiber orientation, length, width, etc.), but parameters of the production of the paper, and thus only secondary or in-direct paper parameters. In a suitable embodiment, the paper parameters accordingly comprise a number of paper production process parameters which were used in the production of the paper roll. The paper production process parameters are in particular operating parameters of a paper machine for producing the paper roll and/or for producing the paper of the paper roll. The paper production process parameters are expediently used to determine a correlative relationship between the production of corrugated cardboard and the production of the paper used in it, which might not be apparent in the direct paper parameters. A subsequent determination of other paper parameters such as failure stress and fiber orientation, temperature, moisture, and the like may therefore be unnecessary, such that, in an advantageous embodiment, these are completely or partially dispensed with. This is based upon the knowledge that ultimately the production of the paper roll significantly influences its properties, and that the production in turn is significantly influenced by the paper production process parameters. Therefore, they are advantageously used directly to adjust the operating parameters of the corrugator.

Suitable paper parameters are listed below:
a) Paper roll properties
   (exact) sleeve outer diameter
   (exact) running meters on the paper roll
   splices in the paper roll
b) History of the paper
   production date
   manufacturer's name
   place of manufacture
   date of manufacture
   storage time
   storage conditions (e.g., moisture and/or ambient temperature)
   transport time
   transport conditions (e.g., moisture and/or ambient temperature)
c) Basic properties of the paper
   moisture/moisture content
   mass per unit area
   thickness
   ash content
   fiber orientation (also fiber orientation angle)
d) Tensile properties of the paper
   breaking strength
   tear length
   elongation at break
   modulus of elasticity
e) Surface/printability properties of the paper
   smoothness, e.g., according to Bekk
   roughness, e.g., according to Bendtsen
   air permeability, e.g., according to Bendtsen/Gurley
f) Corrugated cardboard properties (especially, corrugated cardboard base paper properties)
   flat crush resistance (e.g., according to CMT=Concora Medium Test, FCT=Flat Crush Test, or the like)
   strip crush resistance (e.g., according to SCT=Short Crush Test)

The above list indicates preferred paper parameters, but is not intended to be exhaustive. The use of only a subset of the paper parameters mentioned is already advantageous, but it is particularly useful to use as many paper parameters as possible.

Regardless of whether a paper parameter is static or dynamic, the most suitable paper parameters are those which change as little as possible or not at all during the life of the paper roll, i.e., until it is processed in the corrugator. For example, the temperature of a paper roll typically changes during transport from the paper mill to the corrugator, making it less suitable (but not entirely unsuitable). Moisture is less of a problem than temperature, but it also fundamentally changes over time. By contrast, the grain direction (possibly even as a dynamic paper parameter as a function of width and length) remains unchanged and is therefore particularly suitable.

The determination of the values of the paper parameters is not necessarily a part of the method for operating the corrugator described here. Expediently, at least one and preferably all of the values of the paper parameters of a respective paper roll were determined in advance, viz., before this paper roll is fed to the corrugator. The values of the paper parameters are therefore known before the corrugator is fed with the paper roll and therefore need to be transmitted only to the corrugator in order to set the operating parameters. This ensures uninterrupted and fully automatic operation.

Suitably, the values of the paper parameters of a particular paper roll were already determined during its production, especially in the case of the paper production process parameters mentioned above. Alternatively or additionally, the values of the paper parameters of a respective paper roll were determined after its production and in particular by means of a laboratory test. In general, it is advantageous if at least some of the paper parameters are determined during or immediately after production and in particular by the manufacturer of the paper roll itself and stored appropriately, e.g., on a data carrier, in order to be transmitted later to a corrugator.

It is advantageous to update one or more paper parameters based upon paper data that describes the life cycle of the paper roll, in particular up to the actual processing in the corrugator. The paper data then contains, on the one hand, one or more paper parameters which vary over time (e.g., temperature or moisture) and, in addition, logistics data (i.e., storage, transport, and/or tracking data, e.g., transport duration, transport conditions, storage duration, storage temperature, etc.). The time-varying paper parameter is stored, for example, during or after the production of the paper roll and before it is transported away from the paper mill, and is then subject to further change due to the storage and transport of the paper roll. This change is now tracked using the logistics data in order to then update (i.e., recalculate) the paper parameters, preferably immediately before or during processing in the corrugator. In a suitable embodiment, a temperature and moisture logger travels with the paper roll on a truck, and the initial paper parameters of temperature and moisture from the paper mill are then updated with recorded data from the temperature and moisture logger, e.g., enriched and corrected using a suitable model (e.g., temperature distribution calculations and diffusion equations).

The corrugator expediently has a data interface via which the values of the paper parameters of the paper of a respective paper roll are transmitted to the corrugator. The values are transmitted before, during, and/or after feeding the corrugator, preferably before the paper roll is unwound for processing. Basically, however, it is sufficient if at least those values which are specifically required for processing the incoming paper web in this processing station are transmitted immediately before a respective processing station, in order to set the operating parameters which are assigned to this processing station. However, in keeping with the forward-looking approach preferred here, all values are preferably transmitted together as a single, aggregated data set via the data interface, and are then immediately available.

In a particularly preferred embodiment, each paper roll is assigned a data carrier on which the individual values of the paper parameters of the paper of the respective paper roll are stored. Each data carrier is therefore assigned to exactly one paper roll and, in particular, contains also only the paper data of a single paper roll. To set the operating parameters depending upon the paper parameters, the data carrier is preferably read out from the corrugator. For this purpose, the corrugator has a suitable reader. The reader is in particular a part of the data interface already mentioned. The data carrier is suitably a code, e.g., QR code or barcode, a transponder, e.g., RFID tag or NFC tag, or a volatile or non-volatile memory, e.g., a floppy disk, a CD, or a flash memory. The reader is correspondingly, for example, a scanner, a receiving unit with antenna, a drive, a USB port, or the like. The data carrier enables an offline solution in which the values of the paper parameters are transmitted to the corrugator without the corrugator having to be connected to the Internet or another network in order to receive the data set for a particular paper roll.

The data carrier is either attached to the paper roll or is provided separately from it. In one embodiment, the data carrier is a label or a type of data sheet for the paper roll and is also called a “roll tag.” The data carrier can also advantageously be shipped together with the paper roll. Accordingly, in an advantageous embodiment, the data carrier is attached to the paper roll, e.g., directly on its paper web or on a packaging of the paper roll, e.g., glued or printed directly on the paper or on the sleeve. This makes assigning and handling the data set particularly straightforward. For example, the data carrier is a code which is attached to the paper roll and which is read by a reader when it is fed into the corrugator.

In principle, it is conceivable that a paper roll be used several times (e.g., three times), i.e., after being fed into the corrugator, it is not necessarily used up completely, but only partially, and is then removed from the corrugator and stored again. If necessary, the now partially used paper roll is then fed back into the corrugator at a later time point. The data carrier is therefore preferably designed in such a way that it is reliably linked to the paper roll even when the paper roll is fed into and removed from the corrugator several times. In a suitable embodiment, the data carrier is detachable and is removed when the paper roll is fed in, and re-attached to the paper roll when it is removed and subsequently stored. In another suitable embodiment, the data carrier is attached to the paper roll in such a way that the data carrier does not have to be removed, i.e., remains on the paper roll when it is processed in the corrugator. For this purpose, the data carrier is expediently mounted in the center, in particular on or in a sleeve of the paper roll. Contactless or electronically readable data carriers such as RFID and NFC tags and the like are particularly suitable for this purpose. Overall, this ensures that the paper parameters are available throughout the entire service life of a paper roll, even if it is used multiple times. For the ID already mentioned, which is described in greater detail below, the statements regarding the data carrier apply analogously.

Updating the paper parameters is particularly advantageous when paper rolls are used multiple times. For this purpose, in a suitable embodiment, one or more of the paper parameters of a paper roll are updated if this paper roll is only partially used and is removed from the corrugator and is temporarily stored for later reuse, in particular away from the corrugator, e.g., in a roll storage facility. The update is either a change to an existing paper parameter or an addition of a new paper parameter. It is useful, for example, to update the length of the paper, i.e., to store the remaining length of paper, or the diameter of the paper roll and basically all properties of the paper roll which change during processing in the corrugator. A suitable, newly added paper parameter, for example, is an unwinding direction, i.e., the direction in which the paper roll was unwound during processing (especially for paper from which a wave of the corrugated cardboard web is made). Particularly advantageous is an embodiment in which one or more operating parameters of the corrugated cardboard system which were used when processing the paper roll are stored when the paper parameters are updated, so that when the paper roll is used again, the operating parameters last used for it are immediately accessible and usable. Once selected, the operating parameters are inherited, so to speak. Alternatively or additionally, the update saves which other paper rolls the paper roll was processed with and, optionally, which operating parameters were used. In this way, operating parameters are advantageously learned which are particularly advantageous in interaction with such or similar (e.g., from the same batch) paper rolls. The update is carried out in particular with a writer of the corrugator. Optionally, the reader and the writer can be combined to form one writer and reader.

Alternatively or in addition to the aforementioned offline solution, an online solution is also generally advantageous, e.g., a cloud solution. Such an online solution has the particular advantage that the determination of paper parameters, e.g., by means of a laboratory test, is possible in parallel (i.e., at the same time) with the transport of the paper roll, and the paper parameters are then transmitted online. In a suitable embodiment for this purpose, at least a subset (one or more), in particular each, of the paper rolls has an, in particular, individual ID (also referred to as an identifier or identification mark), which is stored together with the paper data of the respective paper roll in a database, e.g., a data lake. In a suitable embodiment, the database is part of a cloud. The ID is used to assign a specific paper roll to its paper data, which is then determined and/or stored independently of the paper roll. The use of an ID to assign a paper roll to a data record from a set of several aggregated data records has already been outlined above. The database is designed in a suitable manner separately from the corrugator and is connected to it for data trans-mission, e.g., via the Internet or via another network. Another suitable embodiment is one in which the database is part of the corrugator. The database is connected either to a single corrugator or, alternatively, to several corrugators. The corrugator requests the paper data of a particular paper roll from the database using its ID. As soon as the corrugator has received the values, the operating parameters are adjusted accordingly. In principle, it is also possible that the rule used here, if applicable, is also stored in the database and that this then directly transmits the corresponding values for the operating parameters when the corrugator is asked for a given ID. Even with the online solution, the paper parameters are thus used directly to control the corrugator; the ID merely represents a pointer to the database in order to request the corresponding data set, which is not directly attached to the paper roll itself. The ID, on the other hand, is advantageously attached to the paper roll; accordingly, the statements regarding the data carrier also apply analogously to the ID.

A bi-directional interface between the corrugator and a paper machine (or paper mill in general) is also advantageous. On the one hand, paper data are then transferred to the corrugator, via the bi-directional interface, in order to control it as described. On the other hand, the bi-directional interface also transmits corrugated cardboard data to the paper machine in order to control it. In a suitable embodiment, a basically symmetrical constellation is realized in which the corrugated cardboard data contain corrugated cardboard parameters of the corrugated cardboard analogous to the paper data and thus describe properties of the corrugated cardboard. The paper parameters mentioned in connection with the paper data are basically also suitable as corrugated cardboard parameters. Alternatively or additionally, corrugated card-board-specific corrugated cardboard parameters such as warp or quality of gluing are used advantageously. The paper machine is then controlled using the corrugated cardboard data; here, too, the explanations for controlling the corrugator also apply analogously to the control of the paper machine, wherein, specifically, the paper machine is consequently controlled using different operating parameters than a corrugator. A particular advantage of the bi-directional interface is that malformations and rejects in the corrugator are correlated with paper data from the paper roll processed there and reported back to the paper machine, whereupon the machine makes a suitable correction (i.e., changes operating parameters appropriately) in order to produce paper from now on that does not lead to the aforementioned malformations or rejects, or at least only to a lesser extent. In other words, the paper machine receives feedback regarding the suitability of the paper produced by the paper machine, and, depending upon this feedback, the operating parameters of the paper machine are optimized with the aim of improving the subsequent production of corrugated cardboard.

In an expedient embodiment, the corrugator has one or more sensors by means of which the values of the paper parameters of the paper of a respective paper roll are measured, in particular during operation, while this paper roll is accommodated in the corrugator, and preferably before this paper roll is processed. This is also an online solution. According to our interpretation, processing begins with unwinding from an unwinder of the corrugator and includes in particular one or more of the following processing steps: splicing, corrugating (with a corrugating roller), moistening, drying, printing, and gluing and/or joining to another paper web. In principle, all processing steps benefit from knowledge of the actual values of the paper parameters, but especially any processing steps after unwinding or splicing. Accordingly, it is sufficient if the sensors are arranged along the paper web downstream of the unwinder or splicer and upstream of any other processing units. It is also advantageous to integrate the sensors into the unwinder or splicer so that the values of the paper parameters are measured immediately before, during, or after unwinding/splicing.

Alternatively or in addition to one or more actual sensors as described above, the corrugator, in an advantageous embodiment, has a virtual sensor, also referred to as a soft sensor. The virtual sensor does not actually carry out any measurements in the corrugator; instead, the virtual sensor is fed with the paper data, especially those paper parameters that were determined outside the corrugator (e.g., during paper production). Optionally, one or more paper parameters are also fed to the virtual sensor, which were determined as described with an actual sensor in the corrugator. A particularly advantageous embodiment is one in which the aforementioned paper production process parameters are fed to the virtual sensor, since these, in principle, cannot be measured in the corrugator itself. The virtual sensor then determines the operating parameters for the corrugator, in particular from the supplied paper data, and in this respect implements the already mentioned Big Data approach and/or the already described rule for assigning the values of the operating parameters to the values of the paper parameters.

A corrugator according to the invention has a control unit which is designed to carry out a method as described above. The control unit is particularly designed to carry out one or more of the described steps of the method. For this purpose, the control unit controls the processing units accordingly, and thus sets the operating parameters.

Suitably, the corrugator has an order planning system. The order planning system allows the setting of operating parameters to be planned in advance. This is improved accordingly by the individual values of the paper parameters now available for each paper roll. The order planning system queries in particular the paper data of a respective paper roll, e.g., by means of a reader or by means of an ID, and passes these paper data on to the control unit, which then adjusts the operating parameters and thus the individual processing units accordingly, in particular as soon as the respective paper roll is processed.

A computer program product according to the invention comprises commands which, when executed by a corrugator, in particular as described above, cause the corrugator to select and adjust the operating parameters, in a method as described above, depending upon the values of the paper parameters, so that the production of the corrugated cardboard web is individually adapted to the paper of the paper roll fed in each case. In particular, the already mentioned rule for assigning the values of the operating parameters to the values of the paper parameters is also implemented with the computer program product. Suitably, the computer program product also comprises commands which, when executed by a corrugator, implement the stated order planning system for the corrugator.

A paper roll according to the invention is used in particular for producing a corrugated cardboard web and is characterized, as described above, by a number of paper parameters with individual values. The paper roll has a data carrier on which the individual values of the paper parameters are stored. The data carrier is designed in such a way that it can be read by a corrugator in a method as described above, in particular in order to then control the corrugator based upon the values of the paper parameters. Alternatively or additionally, the paper roll has an ID for referencing the values of the paper parameters in a database. The ID is designed to serve as a pointer for requesting the values of the paper parameters from the database by means of a corrugator in a method as described above.

In the following, exemplary embodiments of the invention are explained in more detail with reference to a drawing. In the drawing, schematically:

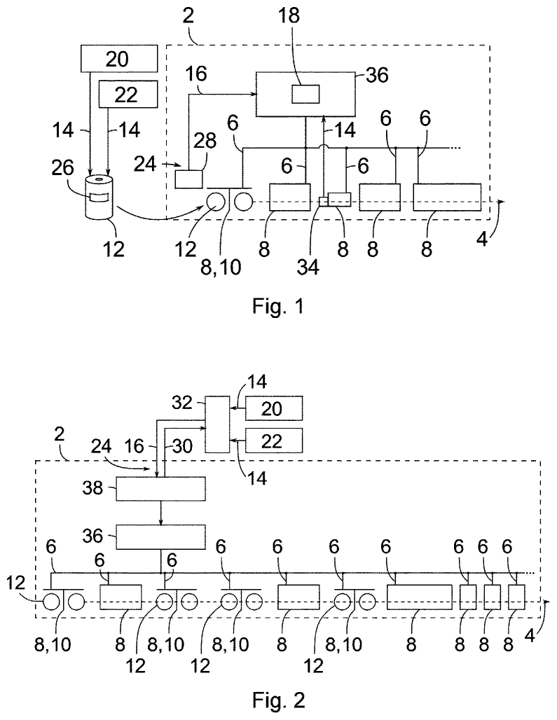

FIG. 1 shows a corrugator,

FIG. 2 shows a variant of the corrugator from FIG. 1.

FIGS. 1 and 2 each show a corrugator 2 to explain exemplary embodiments of a method for operating such a corrugator 2. The corrugator 2 is used to produce a corrugated cardboard web 4 and for this purpose has a number of adjustable operating parameters 6. Here and in general, “a number of” is understood to mean “one or more” or “at least one.” An operating parameter 6 is adjusted by selecting and setting a value for that operating parameter 6. The operating parameters 6 are used to control the behavior of one or more processing units 8 of the corrugator 2. Examples of the processing units 8 are unwinder 10, splicer, printer, single facer, bridge, preheater, gluing unit, double facer, drying section, cutting unit, slitting unit, grooving unit, and the like.

As part of the method, a number of paper rolls 12 are fed to the corrugator 2, each with a paper web made of paper from which the corrugated cardboard web 4 is produced. Each paper roll 12 is formed by a rolled-up paper web, which is unwound from the corrugator 2 for producing the corrugated cardboard web 4 by means of an unwinder 10 and is suitably connected to further paper webs of further paper rolls 12. The processing units 8 then process the paper webs according to the operating parameters 6. In the figures, the course of the paper webs and the corrugated cardboard web 4 through the corrugator 2 is shown only in a highly simplified manner.

The paper rolls 12 are each characterized by a number of paper parameters 14, which have individual values for each of the paper rolls 12, so that each of the paper rolls 12 is individually characterized based upon its values for the paper parameters 14 (also referred to as paper data). The paper parameters 14 each describe, directly or indirectly, one or more properties of the paper of the paper roll 12, so that different values mean or imply different properties. As a rule, two paper rolls 12 differ in one or more of the paper parameters 14 due to their production, storage, transport, etc. This individuality of the paper rolls 12 is taken into account during their processing and used to optimize the production of the corrugated cardboard web 4. For this purpose, the operating parameters 6 are set depending upon the values of the paper parameters 14, so that the production of the corrugated cardboard web 4 is individually adapted to the respective paper roll 12. In the present case, the individual paper data of a paper roll 12 are used to control the corrugator 2, so that its operation then depends upon the individual values of the paper parameters 14 of each paper roll 12. The values used for the paper parameters 14 of a single paper roll 12 are in the present case aggregated as far as possible, i.e., summarized into a data set 16.

In the exemplary embodiments shown, values for the operating parameters 6 are selected on the basis of a rule 18 which links the values of the paper parameters 14 with the values for the operating parameters 6 in such a way that a quality measure for the corrugated cardboard web 4 is maximized. The rule 18, for example, is learned, i.e., is generated in advance in a learning process in which the relationship between the operating parameter 6 and the paper parameter 14 is determined, and the rule 18 is then determined directly from these data or indirectly via a function derived therefrom.

In the present case, the operating parameters 6 are set not only indirectly, but directly dependent upon the values of the paper parameters 14. The rule 18, for example, is a function which has the paper parameters 14 as input parameters and the operating parameters 6 as output parameters. The values of the paper parameters 14 are converted by the corrugator 2 into suitable values for the operating parameters 6 in accordance with the rule 18, and these values are then also set. A determination of any intermediate parameters is preferably not carried out.

Which paper parameters 14 are actually used is initially of secondary importance and becomes less relevant as the number of paper parameters 14 increases. Accordingly, as many paper parameters 14 as possible are used here, e.g., at least 10 or even at least 100. However, some paper parameters 14 regularly have a greater influence on the quality of the corrugated cardboard web 4 than other paper parameters 14 and are therefore, in a possible embodiment, used specifically. For example, one or more of the paper parameters 14 are selected from the following paper parameters 14: fiber orientation of the paper of the paper roll, failure stress of the paper of the paper roll 12.

In one possible embodiment, at least one of the paper parameters 14 is a dynamic paper parameter 14, the values of which are specified as a function of the width and/or length of the paper web of the paper roll 12. By contrast, static paper parameters 14 have the same value along the entire paper web of the paper roll 12. Suitable dynamic paper parameters 14 are moisture and temperature as a function of a width and/or length of the paper web of the paper roll 12.

Alternatively or additionally, the paper parameters 14 comprise a number of paper production process parameters used in the production 20 of the paper of the paper roll 12. The paper production process parameters are operating parameters of a paper machine of a paper mill for producing 20 the paper roll 12 or at least for producing the paper for the paper roll 12.

In the exemplary embodiment shown here, some or all of the values of the paper parameters 14 of a respective paper roll 12 were determined in advance, viz., before this paper roll 12 is fed to the corrugator 2. The values of the paper parameters 14 are therefore known before the corrugator 2 is fed with the paper roll 12 and therefore need to be transmitted only to the corrugator 2 in order to set the operating parameters 6.

In addition, at least some of the values of the paper parameters 14 of a particular paper roll 12 were already determined during its production 20, especially in the case of the paper production process parameters mentioned above. Alternatively or additionally, the values of the paper parameters 14 of a respective paper roll 12 were determined after its production 20 and, for example, by means of a laboratory test 22. For example, the paper parameters 14 of the paper roll 12 are determined and stored during or immediately after production 20 and, if applicable, by the manufacturer of the paper roll itself.

In the exemplary embodiments presented, the corrugator 2 has a data interface 24 via which the values of the paper parameters 14 of a respective paper roll 12 are transmitted to the corrugator 2. The values are transmitted before, during, and/or after feeding the corrugator 2, e.g., before the paper roll 12 is unwound for processing.

In the exemplary embodiment of FIG. 1, each paper roll 12 is assigned a data carrier 26 on which the individual values of the paper parameters 14 of the respective paper roll 12 are stored. Each data carrier 14 is assigned to exactly one paper roll 12 and contains here also only the values of a single paper roll 12. To set the operating parameters 6 depending upon the paper parameters 14, the data carrier 26 is read out from the corrugator 2. For this purpose, the corrugator 2 has a suitable reader 28. The data carrier 26 enables an offline solution in which the values of the paper parameters 14 are transmitted to the corrugator 2 without the corrugator having to be connected to the Internet or another network, in order to receive the data set 16 for a particular paper roll 12. The data carrier 26 can be sent with the paper roll 12 and is, so to speak, a label or a type of data sheet for the paper roll 12. In the embodiment shown here, the data carrier 26 is attached to the paper roll 12.

Alternatively or in addition to the offline solution, an online solution is also generally advantageous. An exemplary embodiment of this is shown in FIG. 2. There, each of the paper rolls 12 has an ID 30, which is stored in a database 32 together with the values of the paper parameters 14 of the respective paper roll 12. The ID 30 is, for example, attached to the paper roll in the same manner as the data carrier 26 in FIG. 1. The database 32 is either designed separately from the corrugator 2 as shown in FIG. 2 or is a part thereof (not shown). The corrugator 2 requests the values of the paper parameters 14 of a respective paper roll 12 from the database 32 based upon its ID 30. As soon as the corrugator 2 has received the values, the operating parameters 6 are adjusted accordingly. In principle, it is also possible that the rule 18 used here, if applicable, is also stored in the database 32 and that this then directly transmits the corresponding values for the operating parameters 6 when the corrugator 2 is asked for a given ID 30. Even with the online solution, the paper parameters 14 are used directly to control the corrugator 2; the ID 30 merely represents a virtual placeholder for the paper roll 12 and its paper data in order to query the associated data set 16.

In the exemplary embodiment of FIG. 1, the corrugator 2 has one or more sensors 34, by means of which some of the values of the paper parameters 14 of a respective paper roll 12 are measured during operation. This paper roll 12 has already been accommodated in the corrugator 2. This is also an online solution. The processing basically begins with the unwinding from the unwinder 10, and then includes all subsequent processing steps. In principle, all processing steps benefit from knowledge of the actual values of the paper parameters 14, but especially any processing steps after unwinding or splicing. Accordingly, unlike what is shown in FIG. 1, it is sufficient if the sensors 34 are arranged along the paper web downstream of the unwinder 10 or the splicer and upstream of any other processing units 8. The solution with one or more sensors 34 is also applicable to the exemplary embodiment of FIG. 2.

The respective corrugator 2 also has a control unit 36 which is designed to carry out the described method. The control unit 36 controls the processing units 8 accordingly and thus sets the operating parameters 6. Furthermore, the corrugator 2 in FIG. 2 also has an order planning system 38, with which the setting of the operating parameters 6 is planned in advance. For example, as shown in FIG. 2, the order planning system 38 uses the ID 30 of a respective paper roll 12 to query the values of the paper parameters 14 of a respective paper roll 12 from the database 32 used and forwards these to the control unit 36, which then sets the operating parameters 6 and thus the individual processing units 8 as soon as the respective paper roll 12 is processed. An order planning system 38 is also possible in the embodiment according to FIG. 1.

The corrugator 2 shown here also executes a computer program product for operation, with commands which cause the corrugator 2 to select and adjust the operating parameters 6 as described in the described method, depending upon the values of the paper parameters 14, so that the production of the corrugated cardboard web 2 is individually adapted to the paper roll 12 fed in each case.

Individual aspects which are described or shown only in connection with one of the exemplary embodiments can in principle also be transferred to the other exemplary embodiments, independently of the other concepts contained in the respective exemplary embodiment.

### LIST OF REFERENCE SIGNS

2 corrugator
4 corrugated cardboard web
6 operating parameters
8 processing unit
10 unwinder
12 paper roll
14 paper parameters
16 data set
18 rule
20 production (of the paper roll)
22 laboratory test
24 data interface
26 data carrier
28 reader
30 ID
32 database
34 sensor
36 control unit
38 order planning system

1. Method for operating a corrugator,
wherein the corrugator serves to produce a corrugated cardboard web and for this purpose has a number of adjustable operating parameters,
wherein a number of paper rolls are fed to the corrugator, each with a paper web made of paper from which the corrugated cardboard web is produced,
wherein the paper rolls are each characterized by a number of paper parameters which have individual values for each of the paper rolls, so that each of the paper rolls is individually characterized based upon its values for the paper parameters,
wherein the operating parameters are set depending upon the values of the paper parameters, so that the production of the corrugated cardboard web is individually adapted to the respective fed paper roll,
wherein values for the operating parameters are selected on the basis of a rule which links the values of the paper parameters with the values for the operating parameters in such a way that a quality measure for the corrugated cardboard web is influenced, in particular improved, in particular maximized,
wherein the rule is or has been empirically determined in advance using a Big Data approach.

2. (canceled)

3. (canceled)

4. Method according to claim 1,
wherein at least 10 paper parameters are used, in particular at least 100.

5. Method according to claim 1,
wherein one or more of the paper parameters are selected from the following paper parameters: fiber orientation of the paper of the paper roll or failure stress of the paper of the paper roll.

6. Method according to claim 1,
wherein the corrugator has a control unit and an order planning system,
wherein the order planning system queries the values of the paper parameters of a respective paper roll by means of a reader or by means of an ID and forwards these values of the paper parameters to the control unit, which then adjusts the operating parameters and thus the individual processing units.

7. Method according to claim 1,
wherein at least one of the paper parameters is a dynamic paper parameter, the values of which are specified as a function of a width and/or length of the paper web of the paper roll.

8. Method according to claim 1,
wherein the paper parameters comprise a number of paper production process parameters used in the production of the paper of a respective paper roll.

9. Method according to claim 1,
wherein the values of the paper parameters of the paper of a respective paper roll were determined before this paper roll is fed to the corrugator.

10. Method according to claim 9,
wherein the corrugator has a data interface via which the values of the paper parameters of the paper of a respective paper roll are transmitted to the corrugator.

11. Method according to claim 1,
wherein at least a subset, in particular each, of the paper rolls has an ID which is stored in a database together with the values of the paper parameters of the paper of the respective paper roll,
wherein the corrugator requests the values of the paper parameters of the paper of a respective paper roll from the database based upon its ID.

12. Method according to claim 1,
wherein the corrugator has one or more sensors by means of which the values of the paper parameters of the paper of a respective paper roll are measured while this is accommodated in the corrugator.

13. Corrugator, which has a control unit which is designed to carry out a method according to claim 1.

14. Computer program product, comprising commands which, when executed by a corrugator, cause the corrugator, the method according to claim 1, to select and adjust the operating parameters in each case depending upon the values of the paper parameters, so that the production of the corrugated cardboard web is individually adapted to the paper of the paper roll fed in each case.

15. (canceled)

16. Method for operating a corrugator,
wherein the corrugator serves to produce a corrugated cardboard web and for this purpose has a number of adjustable operating parameters,
wherein a number of paper rolls are fed to the corrugator, each with a paper web made of paper from which the corrugated cardboard web is produced,
wherein the paper rolls are each characterized by a number of paper parameters which have individual values for each of the paper rolls, so that each of the paper rolls is individually characterized based upon its values for the paper parameters,
wherein the corrugator is controlled individually for each roll, and the operating parameters are set depending upon the values of the paper parameters, so that the production of the corrugated cardboard web is individually adapted to the respective fed paper roll.

17. The method according to claim 16, wherein values for the operating parameters are selected on the basis of a rule which links the values of the paper parameters with the values for the operating parameters in such a way that a quality measure for the corrugated cardboard web is influenced, in particular improved, in particular maximized.

18. The method according to claim 1,
wherein each paper roll is assigned a data carrier on which the individual values of the paper parameters of the paper of the respective paper roll are stored,
wherein the data carrier is in particular read out by the corrugator.

19. The method according to claim 18, wherein the data carrier is attached to the paper roll.

20. The method according to claim 1, wherein the corrugator has a control system due to the use of the paper parameters for control, which is a feedforward control in which the paper roll as an input product supplies an input signal for the control system in order to control the operating parameters.
